(19) United States
(12) Patent Application Publication
(10) Pub. No.: US 2026/0269897 A1
(43) Pub. Date: Sep. 10, 2026

(54) Methods And Apparatus For Determining An Array Associated With Resource Allocation In An Integrated Sensing And Communication System

(71) Applicant: MediaTek Inc., Hsinchu City (TW)

(72) Inventors: Jiaying Ren, San Jose, CA (US); Shiauhe Shawn Tsai, San Jose, CA (US)

(73) Assignee: MediaTek Inc., Hsinchu City (TW)

(21) Appl. No.: 19/466,285

(22) Filed: Jan. 31, 2026

Related U.S. Application Data
(60) Provisional application No. 63/757,893, filed on Feb. 13, 2025.

(51) Int. Cl. H04B 7/06; H04B 7/08

(52) U.S. Cl. CPC H04B 7/0617; H04B 7/0842

(57) ABSTRACT

Various solutions for determining an array associated with resource allocation with respect to an apparatus in an Integrated Sensing and Communication (ISAC) system are described. The apparatus may determine a plurality of kernels of an array associated with a resource allocation. The array is configured such that: (1) a half power beamwidth of Point Spread Function (PSF) associated with the array is within a respective threshold in each corresponding dimension; and (2) a Peak Sidelobe Level (PSL) of PSF associated with the array is under a threshold. The apparatus may transmit or receive a plurality of signals based on the array associated with the resource allocation.

### CROSS REFERENCE TO RELATED PATENT APPLICATION(S)

The present disclosure is part of a non-provisional application claiming the priority benefit of U.S. Patent Application No. 63/757,893, filed 13 Feb. 2025, the content of which herein being incorporated by reference in its entirety.

### TECHNICAL FIELD

The present disclosure is generally related to an Integrated Sensing and Communication (ISAC) system, and, more particularly, to determining an array associated with resource allocation in an ISAC system.

### BACKGROUND

Unless otherwise indicated herein, approaches described in this section are not prior art to the claims listed below and are not admitted as prior art by inclusion in this section.

Regarding New Radio (NR) mobile communications, in some network environments related to radar engineering, the detection of surrounding objects may typically be achieved through the measurement of signal delay and Doppler shift. Wireless signals, transmitted across frequency, time, and/or spatial domains for communication purposes, exhibit radio characteristics analogous to those employed in sensing applications. These characteristics may be repurposed to enable dual communication and sensing functionalities. The design and implementation of multi-dimensional, large-scale sparse arrays may represent a critical area of research in the field of integrated sensing and communication, as such arrays provide a foundation for optimizing performance, reducing resource overhead, and addressing the challenges associated with simultaneous sensing and communication requirements. However, the designs of these large-scale arrays may be too complicated, so that the computational complexity may be significantly high.

Accordingly, the development of an array design scheme that minimizes computational complexity has become a critical consideration in the advancement of modern wireless communication networks. Therefore, there is a recognized need for effective schemes that enable a more streamlined and efficient array design process.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining an array associated with resource allocation with respect to apparatus in an ISAC system.

In one aspect, a method may involve an apparatus determining a plurality of kernels of an array associated with a resource allocation. The array may be configured such that: a half power beamwidth of Point Spread Function (PSF) associated with the array is within a respective threshold in each corresponding dimension; and a Peak Sidelobe Level (PSL) of PSF associated with the array is under a first threshold. The method may further involve the apparatus transmitting a plurality of signals based on the array associated with the resource allocation.

In one aspect, a method may involve an apparatus determining a plurality of kernels of an array associated with a resource allocation. The plurality of kernels may include a first kernel and a second kernel. The array may be configured such that: a half power beamwidth of PSF associated with the array is within a respective threshold in each corresponding dimension; and a number of non-zero elements of the first kernel is associated with a first value and a number of non-zero elements of the second kernel is associated with a second value. The method may further involve the apparatus transmitting a plurality of signals based on the array associated with the resource allocation.

In one aspect, an apparatus may comprise at least one of a transmitter and a receiver, during operation, wirelessly communicates with a wireless network. The apparatus may also comprise a processor communicatively coupled to the at least one of the transmitter and the receiver. The processor, during operation, may perform operations comprising determining a plurality of kernels of an array associated with a resource allocation. The array may be configured such that: a half power beamwidth of PSF associated with the array is within a respective threshold in each corresponding dimension; and a PSL of PSF associated with the array is under a first threshold. The processor may further perform operations comprising transmitting, via the transmitter, or receiving, via the receiver, a plurality of signals based on the array associated with the resource allocation.

In one aspect, an apparatus may comprise at least one of a transmitter and a receiver, during operation, wirelessly communicates with a wireless network. The apparatus may also comprise a processor communicatively coupled to the at least one of the transmitter and the receiver. The processor, during operation, may perform operations comprising determining a plurality of kernels of an array associated with a resource allocation. The plurality of kernels may include a first kernel and a second kernel. The array may be configured such that: a half power beamwidth of PSF associated with the array is within a respective threshold in each corresponding dimension; and a number of non-zero elements of the first kernel is associated with a first value and a number of non-zero elements of the second kernel is associated with a second value. The processor may further perform operations comprising transmitting, via the transmitter, or receiving, via the receiver, a plurality of signals based on the array associated with the resource allocation.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1A is a diagram depicting an example scenario under schemes in accordance with implementations of the present disclosure.

FIG. 1B is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication apparatus in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining an array associated with resource allocation with respect to apparatus in an ISAC system. According to the present disclosure, a number of possible solutions may be implemented separately or jointly. That is, although these possible solutions may be described below separately, two or more of these possible solutions may be implemented in one combination or another.

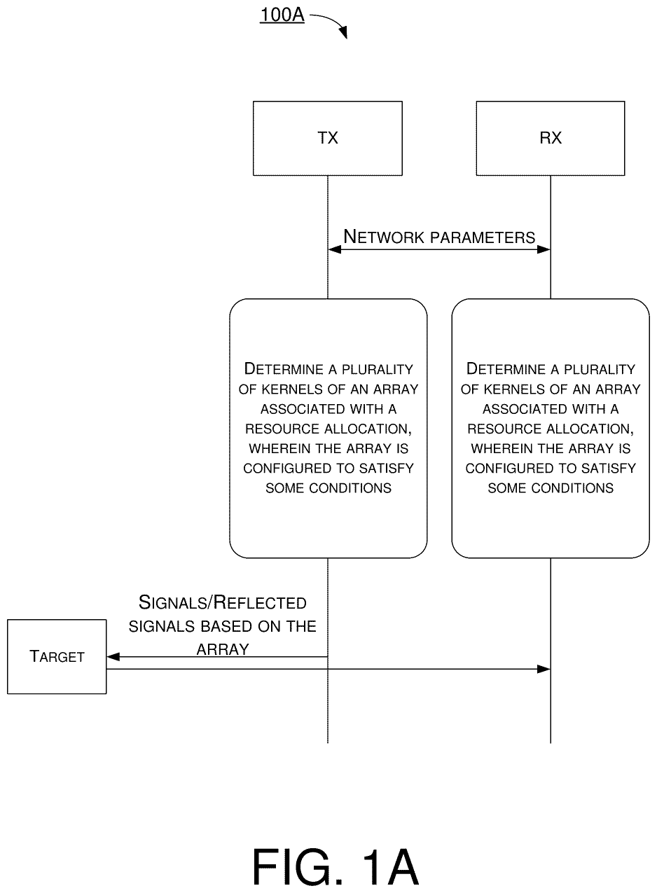

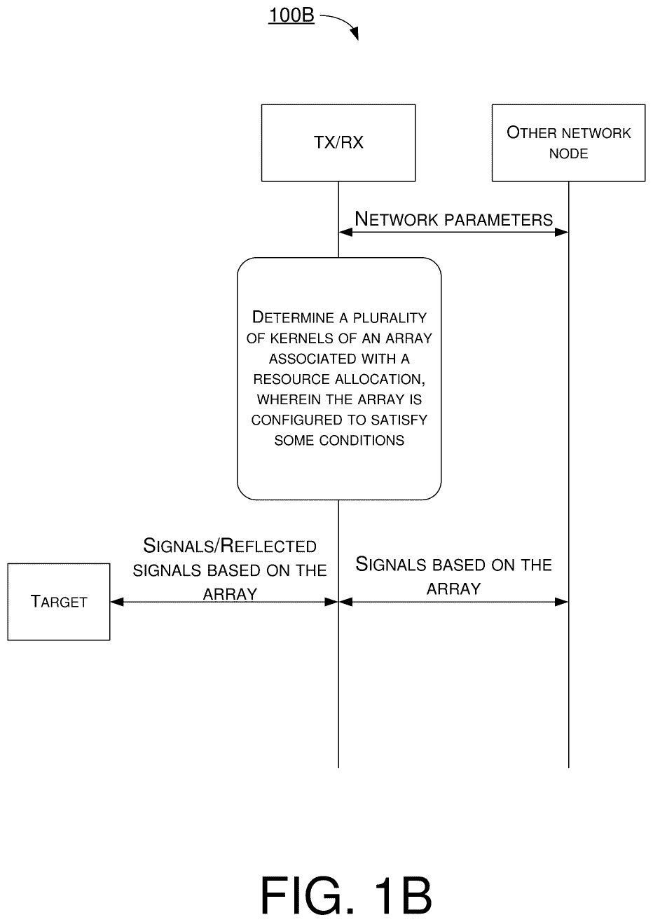

FIG. 1A illustrates an example scenario 100A under schemes in accordance with implementations of the present disclosure. In some network scenarios, an apparatus (e.g., a user equipment (UE) or a network node) may act as a transmitter (TX), and an apparatus (e.g., a UE or a network node) may act as a receiver (RX). The TX and the RX may exchange necessary network parameters.

Then, the TX apparatus and the RX apparatus may respectively determine a plurality of kernels of an array associated with a resource allocation. The array may satisfy some conditions. After determining the array, the TX apparatus may transmit signals to sensing targets, and the RX apparatus may receive the signals reflected from the sensing targets (e.g., for sensing and communication purposes under bistatic sensing network scenarios) based on the array associated with the resource allocation.

FIG. 1B illustrates an example scenario 100B under schemes in accordance with implementations of the present disclosure. In some network scenarios, an apparatus (e.g., a user equipment (UE) or a network node) may act as both a TX and an RX.

Then, the apparatus may determine a plurality of kernels of an array associated with a resource allocation. The array may satisfy some conditions. After determining the array, the apparatus may transmit or receiver signals (e.g., for sensing targets and communication with other network node under monostatic sensing network scenarios) based on the array associated with the resource allocation.

Based on determining the kernels of the array, the design problem of the array may be simplified to several minor design problems of the kernels, which may significantly reduce the computational complexity. Accordingly, effective schemes that enable a more streamlined and efficient array design process may be provided.

More specifically, a multi-tier array structure (i.e., an array structure composed of kernels) for a multi-dimensional array (e.g., a large-scale sparse array) design may be introduced. By using the multi-tier array structure, the array design problem may be simplified to several kernel design problems. The multi-tier array structure may inherently enable a systematic construction of multi-dimensional array patterns, significantly reducing computational complexity for array selection (e.g., sparse array selection) and saving the required storage area, potentially eliminating the need for storage entirely.

Further, the multi-tier array structure may be introduced for low overhead and high performance sensing resource allocation for sensing and positioning in Orthogonal Frequency Division Multiplexing (OFDM) Integrated Sensing And Communication (ISAC) systems, sparse transmission/reception antenna array design for beamforming in massive Multi-Input Multi-Output (MIMO), and other applications requiring a large-scale sparse array. The method may be generally applicable to any resource grids that are used as sampling instances; thus, it is not restricted to the OFDM resource element (RE) plane but also helps heterogeneous time division multiplexing (TDM) radars.

In some embodiments, the TX/RX may determine a plurality of kernels of an array associated with a resource allocation. The array may be configured such that (i.e., may be determined to satisfy the following conditions): (1) a half power beamwidth (i.e., half power main lobe beamwidth) of Point Spread Function (PSF) associated with the array is within a respective threshold in each corresponding dimension (e.g., in two-dimension scenario, the half power beamwidth of PSF associated with the array is within a threshold Δ1 in a first dimension and within a threshold Δ2 in a second dimension); and (2) sidelobe level of PSF associated with the array is suppressed, specifically, a Peak Sidelobe Level (PSL) of PSF associated with the array is under a first threshold.

After determining the array, the TX/RX may transmit or receive signals based on the array associated with the resource allocation. For example, a UE as the TX may transmit the signals to a network node as the RX. A network node as the TX may transmit the signals to a UE as the RX. An apparatus (e.g., network node or UE) as both TX and RX may transceive signals for sensing and communication purposes.

In some implementations, the plurality of kernels may include a first kernel and a second kernel. The array may be a Kronecker product of the first kernel and the second kernel according to the following formula:

$$A = {A}_{2} ⊗ {A}_{1}$$

where A may be the array, A₁ may be the first kernel, and A₂ may be the second kernel. In addition, a size of the array may be P×Q, a size of A₁ may be P₁×Q₁, a size of A₂ may be P₂×Q₂, P may be equal to P₁×P₂, and Q may be equal to Q₁×Q₂.

More specifically, A∈{0,1}^{P×Q} may denote an array pattern of the array with size P×Q. When it is designed that P=P₁×P₂ and Q=Q₁×Q₂, array A with size P×Q may be determined by using: (1) the first kernel with size P₁×Q₁ while A₁∈{0,1}^{P}^{₁}^{×Q}^{₁} and (2) the second kernel with size P₂×Q₂ while A₂∈{0,1}^{P}^{₂}^{×Q}^{₂}, represented as A=A₂⊗A₁. In the first kernel with size P₁×Q₁, there may be P₁ elements in 1^{st} dimension and Q₁ elements in 2^{nd} dimension. In the second kernel with size P₂×Q₂, there may be P₂ number of first kernels in 1^{st} dimension and Q₂ number of first kernels in the 2^{nd} dimension.

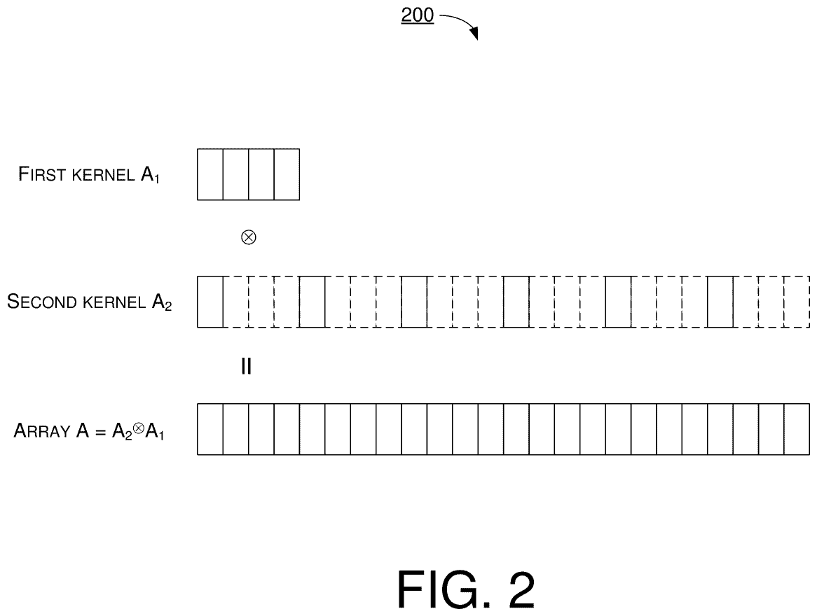

FIG. 2 illustrates an example scenario 200 under schemes in accordance with implementations of the present disclosure. For example, a one-dimension two-kernel array is illustrated in FIG. 2. In particular, the first kernel is A₁, the second kernel is A₂, and the array (i.e., one-dimension two-kernel array) is A=A₂⊗A₁.

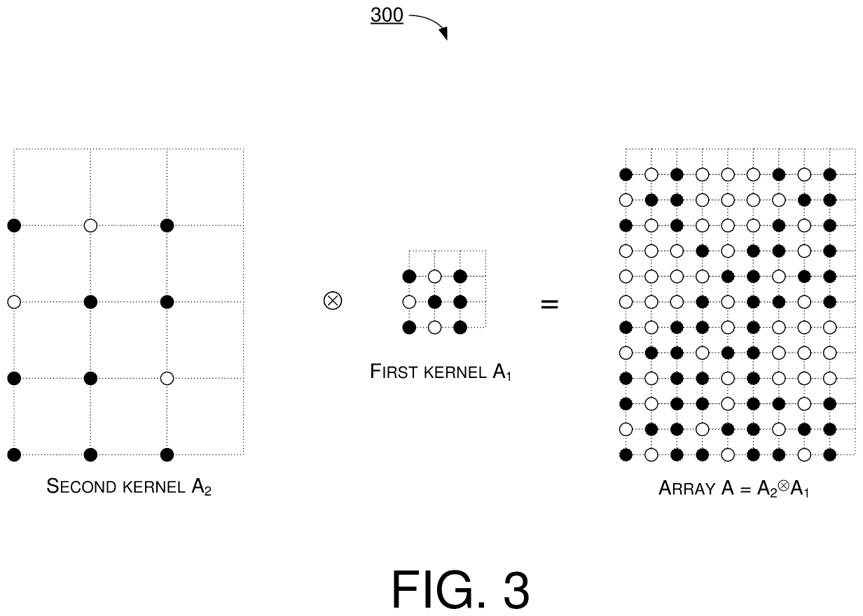

FIG. 3 illustrates an example scenario 300 under schemes in accordance with implementations of the present disclosure. For example, two-dimension two-kernel array is illustrated in FIG. 3. In particular, the first kernel is A₁, the second kernel is A₂, and the array (i.e., two-dimension two-kernel array) is A=A₂⊗A₁. As shown in FIG. 3, regarding the array determined by the first kernel and the second kernel, in the first kernel with size P₁×Q₁, there may be P₁ elements in 1^{st} dimension and Q₁ elements in 2^{nd} dimension; and in the second kernel with size P₂×Q₂, there may be P₂ number of first kernels in 1^{st} dimension and Q₂ number of first kernels in the 2^{nd} dimension.

In some cases, an array factor for the array A may be determined according to the following formula, while [symbol] ᵢ denotes the number of nonzero elements in Aᵢ, for i=1, 2 and [symbol] = [symbol] ᵢ [symbol] ₂ is the number of nonzero elements in A:

$$f ( {α}_{1} , {α}_{2} ) = \frac{1}{ℳ} {\sum }_{q = 1 , p = 1}^{Q , P} a ( p , q ) exp ( - j 2 π {α}_{2} ( q - 1 ) ) exp ( j 2 π {α}_{1} ( p - 1 ) )$$

where ƒ(α₁,α₂) may be the array factor for the array, a(p,q) may be pth row and qth column element of the array A, a(p,q) may be an activated element in an event that a(p,q) is 1, and a(p,q) may not be an activated element in an event that a(p,q) is 0.

In some cases, an array factor for the first kernel A₁ may be determined according to the following formula:

$${f}_{1} ( {α}_{1} , {α}_{2} ) = \frac{1}{{ℳ}_{1}} {\sum }_{{q}_{1} = 1 , {p}_{1} = 1}^{{Q}_{1} , {P}_{1}} {a}_{1} ( {p}_{1} , {q}_{1} ) exp ( - j 2 π {α}_{2} ( {q}_{1} - 1 ) ) exp ( j 2 π {α}_{1} ( {p}_{1} - 1 ) )$$

where ƒ₁(α₁, α₂) may be the array factor for the first kernel A₁, a₁(p₁,q₁) may be p₁th row and q₁th column element of the first kernel A₁, a₁(p₁,q₁) may be an activated element in an event that a₁(p₁,q₁) is 1, and a₁(p₁,q₁) may not be an activated element in an event that a₁(p₁,q₁) is 0. It may be represented as A₁={a₁(p₁,q₁)}∈{0,1}^{P}^{₁}^{×Q}^{₁}.

In some cases, an array factor for the second kernel A₂ may be determined according to the following formula:

$${f}_{2} ( {α}_{1} , {α}_{2} ) = \frac{1}{{ℳ}_{2}} {\sum }_{{q}_{2} = 1 , {p}_{2} = 1}^{{Q}_{2} , {P}_{2}} {a}_{2} ( {p}_{2} , {q}_{2} ) exp ( - j 2 π {f}_{d} {α}_{2} {Q}_{1} ( {q}_{2} - 1 ) ) exp ( j 2 π {α}_{1} {P}_{1} ( {p}_{2} - 1 ) )$$

where ƒ₂(α₁, α₂) may be the array factor for the second kernel A₂, a₂(p₂,q₂) may be p₂th row and q₂th column element of the second kernel A₂, a₂(p₂,q₂) may be an activated element in an event that a₂(p₂,q₂) is 1, and a₂(p₂,q₂) may not be an activated element in an event that a₂(p₂,q₂) is 0.

In some cases, the array factors for the array A, the first kernel A₁ and the second kernel A₂ may be represented as the following formula:

$$f ( {α}_{1} , {α}_{2} ) = {f}_{1} ( {α}_{1} , {α}_{2} ) {f}_{2} ( {α}_{1} , {α}_{2} )$$

where a(p,q) may be equal to a₂(p₂,q₂)a₁(p₁,q₁) for p is equal to p₁+(p₂−1)P₁−1 and q is equal to q₁+(q₂−1)Q₁−1.

More specifically, based on the above designs, the design problem of the array A (with size P×Q) may be simplified to the design problems of two kernels (i.e., the first kernel A₁ with size P₁×Q₁ and the second kernel A₂ with size P₂×Q₂).

It should be noted that there may be the following properties associated with the first kernel and the second kernel. Regarding property of the array factor for the first kernel with a₁(p₁,q₁)=1 for all p₁,q₁, (1) large unambiguous region: a₁∈[−0.5,0.5), a₂∈[−0.5,0.5), and (2) wide main lobe: 3 dB beamwidth

$${Δ}_{{α}_{1}} = \frac{1}{{P}_{1}} , {Δ}_{{α}_{2}} = \frac{1}{{Q}_{1}} .$$

Regarding property of the array factor for the second kernel with a₂(p₂,q₂)=1 for all p₂,q₂, (1) small unambiguous region:

$${α}_{1} ∈ [ - \frac{1}{2 {P}_{1}} , \frac{1}{2 {P}_{1}} ) , {α}_{2} ∈ [ - \frac{1}{2 {Q}_{1}} , \frac{1}{2 {Q}_{1}} ) ,$$

and (2) fine main lobe: 3 dB beamwidth

$${Δ}_{{α}_{1}} = \frac{1}{{P}_{2} {P}_{1}} , {Δ}_{{α}_{2}} = \frac{1}{{Q}_{2} {Q}_{1}} .$$

Regarding periodic property of the array factor for any second kernel: for any (α₁, α₂), define

$${α}_{1} = {α}_{1}^{′} + \frac{1}{{P}_{1}} and {α}_{2} = {α}_{2}^{′} + \frac{1}{{Q}_{1}} ,$$

$${f}_{2} ( {α}_{1}^{′} , {α}_{2}^{′} ) = {f}_{2} ( {α}_{1} , {α}_{2} ) = \frac{1}{{ℳ}_{2}} {\sum }_{{q}_{2} = 1 , {p}_{2} = 1}^{{Q}_{2} , {P}_{2}} {a}_{2} ( {p}_{2} , {q}_{2} ) exp ( - j 2 π {Q}_{1} {α}_{2} ( {q}_{2} - 1 ) ) exp ( j 2 π {P}_{1} {α}_{1} ( {p}_{2} - 1 ) )$$

where ƒ₂(α₁, α₂) may be a two-dimension periodic function with periods of

$$\frac{1}{{P}_{1}}$$

in 1^{st} dimension and

$$\frac{1}{{Q}_{1}}$$

in 2^{nd} dimension. ƒ₂(α₁, α₂) may exhibit periodic grating lobes at

$$( {α}_{1} = \frac{{p}_{1}}{{P}_{1}} , {α}_{2} = \frac{{q}_{1}}{{Q}_{1}} ) ,$$

where p₁,q₁ may be integers and at least one of pᵢ,q₁ may be nonzero,

$$\vert {p}_{1} \vert \leq \frac{{P}_{1}}{2} , and \vert {q}_{1} \vert \leq \frac{{Q}_{1}}{2} .$$

In some implementations, the following sensing resource allocation metrics may be considered: the half power main lobe beamwidth of PSF ƒ(α₁, α₂) along a first dimension and a second dimension, a PSL of PSF ƒ(α₁, α₂), and a number of sensing Resource Elements (REs).

In some implementations, an objective may be to construct a sparse array (i.e., matrix) A that satisfies the following conditions: (C1) the half power main lobe beamwidth of PSF ƒ(α₁,α₂) is within a respective threshold along each corresponding dimension (e.g., in two-dimension scenario, the half power beamwidth of PSF associated with the array is within a threshold Δ1 along the first dimension α₁ and within a threshold Δ2 along the second dimension α₂), and (C2) the PSL of PSF ƒ(α₁, α₂) is under a first threshold. In some cases, the respective threshold and the first threshold may be prescribed values.

More specifically, Ψₛ=Ψ\Ψₘ may denote a sidelobe region, where Ψ may represent an area of interest and Ψₘ may represent a main lobe region. Further, within a multi-dimensional period (i.e., two-dimensional period indexed as (0,0)^{th} in these implementations) of an outer PSF factor (i.e., ƒ₂(α₁,α₂)) associated with the second kernel A₂, may be denoted as Ω^{0,0},

$${Ω}_{o , m}^{0 , 0} = {Ψ}_{m}$$

may represent a two-dimensional main lobe region, and

$${Ω}_{o , s}^{0 , 0} = {Ω}^{0 , 0} ∖ {Ψ}_{m}$$

may represent a corresponding two-dimensional sidelobe region.

Additionally, with respect to an inner PSF factor (i.e., ƒ₁(α₁, α₂)) associated with the first kernel A₁, Ω_{i,m} may represent a two-dimensional main lobe region, and Ω_{i,s}=Ψ\Ω_{i,m} may represent a corresponding two-dimensional sidelobe region.

Based on the above region definitions, a 2-tier structured sparse array (i.e., the sparse array including a sparse inner kernel and a sparse outer kernel) that satisfies conditions associated with the half power main lobe beamwidth and the PSL of PSF ƒ(α₁, α₂) may be constructed in a sequential procedure, as described below.

In the first stage, the sparse inner kernel (i.e., the first kernel A₁) may be configured to satisfy the following conditions S1-inner, S2-inner and S3-inner.

In some cases, the condition S1-inner may limit the half power main lobe beamwidth of the inner PSF factor (i.e., ƒ₁(α₁, α₂)) associated with the sparse inner kernel (i.e., the first kernel A₁) within a respective value in each corresponding dimension (e.g., in two-dimension scenario, the condition S1-inner may limit the half power main lobe beamwidth of the inner PSF factor associated with the sparse inner kernel within

$$\frac{1}{{P}_{1}}$$

in the first dimension α₁ and within

$$\frac{1}{{Q}_{1}}$$

in the second dimension α₂).

In some cases, the condition S2-inner may limit the magnitude of the inner PSF factor (i.e., ƒ₁(α₁, α₂)) associated with the sparse inner kernel (i.e., the first kernel A₁) within the grating lobe regions of the outer PSF factor (i.e., ƒ₂(α₁, α₂)) associated with the sparse outer kernel (i.e., the second kernel A₂), over the area of interest Ψ, to be less than (i.e., remain below) a second threshold. In some cases, the second threshold may be less than or equal to the first threshold.

In some cases, the condition S3-inner may limit the inner PSF factor (i.e., ƒ₁(α₁, α₂)) associated with the sparse inner kernel (i.e., the first kernel A₁) to be less than a predefined value (e.g., a value around −3 dB) within the sidelobe region Ω_{i,s} associated with the sparse inner kernel (i.e., the first kernel A₁).

In the second stage, after the sparse inner kernel (i.e., the first kernel A₁) is configured, the sparse outer kernel (i.e., the second kernel A₂) may be configured to satisfy the following conditions S1-outer and S2-outer.

In some cases, the condition S1-outer may limit the half power main lobe beamwidth of resulting PSF ƒ(α₁, α₂) associated with the sparse array (i.e., the array A) within the respective threshold in each corresponding dimension (e.g., the condition S1-outer may limit the half power main lobe beamwidth of resulting PSF associated with the sparse array within the threshold Δ1 in the first dimension α₁ and within the threshold Δ2 in the second dimension α₂).

In some cases, the condition S2-outer may limit an absolute value of resulting PSF |ƒ(α₁, α₂)| associated with the sparse array (i.e., the array A) to be less than the first threshold within the sidelobe region

$${Ω}_{o , s}^{0 , 0}$$

associated with the sparse outer kernel (i.e., the second kernel A₂).

It should be noted that the condition S1-outer in the second stage may ensure that PSF ƒ(α₁, α₂) satisfies the condition (C1). Further, the condition S2-inner in the first stage may ensure that PSF ƒ(α₁, α₂) in the grating lobe regions of the outer PSF factor is below the second threshold, while the conditions S1-inner, S3-inner and S2-outer may ensure that PSF ƒ(α₁, α₂)≤γ in other area of Ψₛ. It is further noted that the (0,0)^{th} period of the outer PSF factor may be aligned with the half power mainlobe region of the inner PSF factor. As a result of such alignment, within Ψₛ, the inner PSF factor exhibits a lower magnitude in an outside-inner-kernel-3 dB-mainlobe region of the outer PSF factor compared to that in the (0,0)^{th} period. This characteristic may be exploited in the present construction. Thus, the P×Q sparse array (i.e., the array A) satisfying (C1) and (C2) may be constructed by a sequential procedure of configuring the sparse inner kernel and the sparse outer kernel. In some cases, the condition S3-inner may be applied only when the second threshold is selected to be excessively loose, and may be verified after completion of the configuration.

In some implementations, the plurality of kernels may include L number of kernels. The array may be a Kronecker product of the L kernels according to the following formula:

$$A = {A}_{L} ⊗ {A}_{L - 1} ⊗ {A}_{L - 2} ⊗ … ⊗ {A}_{2} ⊗ {A}_{1}$$

where A may be the array, and A₁ to A_{L} may be the L kernels. In addition, a size of the array may be P×Q, a size of Aₗ may be Pₗ×Qₗ, P may be equal to P₁×P₂× . . . ×P_{L-1}×P_{L}, and Q may be equal to Q₁×Q₂× . . . ×Q_{L-1}×Q_{L}.

More specifically, A∈{0,1}^{P×Q} may denote an array pattern of the array with size P×Q. When it is designed that P=P₁×P₂× . . . ×P_{L-1}×P_{L} and Q=Q₁×Q₂× . . . ×Q_{L-1}×Q_{L}, array A with size P×Q may be determined by using the kernel with size Pₗ×Qₗ while Aₗ∈{0,1}^{P}^{ₗ}^{×Q}^{ₗ}, represented as A=A_{L}⊗A_{L-1}⊗A_{L-2}⊗ . . . ⊗A₂⊗A₁.

In some cases, an array factor for the array A may be determined according to the following formula while [symbol] ₗ denotes the number of nonzero elements in Aₗ, for l=1, 2, . . . , L and [symbol] = [symbol] ₁× [symbol] ₂× . . . × [symbol] _{L} is the number of nonzero elements in A:

$$f ( {α}_{1} , {α}_{2} ) = \frac{1}{ℳ} {\sum }_{q = 1 , p = 1}^{Q , P} a ( p , q ) exp ( - j 2 π {α}_{2} ( q - 1 ) ) exp ( j 2 π {α}_{1} ( p - 1 ) ) = {\sum }_{{q}_{L} , {p}_{L}}^{{Q}_{L} , {P}_{L}} {a}_{L} ( {p}_{L} , {q}_{L} ) exp ( - j 2 π {α}_{2} {Q}_{1} {Q}_{2} … {Q}_{L - 1} ( {q}_{L} - 1 ) ) exp ( j 2 π {α}_{1} {P}_{1} {P}_{2} … {P}_{L - 1} ( {p}_{L} - 1 ) ) … {\sum }_{{q}_{2} , {p}_{2}}^{{Q}_{2} , {P}_{2}} {a}_{2} ( {p}_{2} , {q}_{2} ) exp ( - j 2 π {α}_{2} {Q}_{1} ( {q}_{2} - 1 ) ) exp ( j 2 π {α}_{1} {P}_{1} ( {p}_{2} - 1 ) ) {\sum }_{{q}_{1} , {p}_{1}}^{{Q}_{1} , {P}_{1}} {a}_{1} ( {p}_{1} , {q}_{1} ) exp ( - j 2 {πα}_{2} ( {q}_{1} - 1 ) ) exp ( j 2 π {α}_{1} ( {p}_{1} - 1 ) )$$

where ƒ(α₁, α₂) may be the array factor for the array, a(p,q) may be pth row and qth column element of the array A, a(p,q) may be an activated element in an event that a(p,q) is 1, and a(p,q) may not be an activated element in an event that a(p,q) is 0.

In some cases, an array factor for the kernel Aₗ may be determined according to the following formula:

$${f}_{l} ( {α}_{1} , {α}_{2} ) = \frac{1}{{ℳ}_{l}} {\sum }_{{q}_{l} , {p}_{l}}^{{Q}_{l} , {P}_{l}} {a}_{l} ( {p}_{l} , {q}_{l} ) exp ( - j2π {α}_{2} {Q}_{1} {Q}_{2} … {Q}_{l - 1} ( {q}_{l} - 1 ) ) exp ( j 2 π {α}_{1} {P}_{1} {P}_{2} … {P}_{l - 1} ( {p}_{l} - 1 ) )$$

where ƒₗ(α₁, α₂) may be the array factor for the kernel Aₗaₗ(pₗ,qₗ) may be pₗth row and qₗth column element of the kernel Aₗ, aₗ(pₗ,qₗ) may be an activated element in an event that aₗ(pₗ,qₗ) is 1, and aₗ(pₗ,qₗ) may not be an activated element in an event that aₗ(pₗ,qₗ) is 0. It may be represented as Aₗ={aₗ(pₗ,qₗ)}∈{0,1}^{P}^{ₗ}^{×Q}^{ₗ}.

In some cases, the array factors for the array A, the kernels A₁ to A_{L} may be represented as the following formula:

$$f ( {α}_{1} , {α}_{2} ) = {f}_{1} ( {α}_{1} , {α}_{2} ) {f}_{2} ( {α}_{1} , {α}_{2} ) … {f}_{L} ( {α}_{1} , {α}_{2} )$$

where a(p,q) may be equal to a_{L}(p_{L},q_{L})a_{L-1}(p_{L-1},q_{L-1}) . . . a₂(p₂,q₂)a₁(p₁,q₁) for p is equal to p₁+(p₂−1)P₁+ . . . +(p_{L}−1)P₁P₂ . . . P_{L-1} and q is equal to q₁+(q₂−1)Q₁+ . . . +(q_{L}−1)Q₁Q₂ . . . Q_{L-1}.

More specifically, based on the above designs, the design problem of the array A (with size P×Q) may be simplified to the design problems of kernels (i.e., the kernels A₁ to A_{L} with sizes Pₗ×Qₗ for l=1, . . . , L).

According to the first criterion, an objective may be to construct a sparse array (i.e., matrix) A that satisfies the following conditions: (C1) the half power main lobe beamwidth of PSF ƒ(α₁, α₂) is within the respective threshold along each corresponding dimension (e.g., in two-dimension scenario, the half power beamwidth of PSF associated with the array is within the threshold Δ1 along the first dimension α₁ and within the threshold Δ2 along the second dimension α₂; and (C2) the PSL of PSF ƒ(α₁, α₂) is under the first threshold. In some cases, the respective threshold and the first threshold may be prescribed values.

More specifically, within the lth-tier kernel factor (i.e., ƒₗ(α₁, α₂)), Ω_{l,m} may represent two-dimensional main lobe regions, and Ω_{l,s}=Ψ\Ω_{l,m} may represent two-dimensional sidelobe regions. It should be noted that, for the 1st-tier kernel factor,

$${Ω}_{0}^{1 , 1} = Ψ .$$

There may be l stages for l tiers kernels of the array. In the first two stages (i.e., l=1 and l=2), the 1st-tier and 2nd-tier kernels may be considered as the inner kernel and outer kernel, respectively. The previously mentioned sequential procedure for two-tier case (i.e., two kernels case) may be applied to derive these two kernels with the respective threshold (e.g., the threshold

$${Δ}_{1} = \frac{1}{{P}_{1} {P}_{2}}$$

and the threshold

$${Δ}_{2} = \frac{1}{{Q}_{1} {Q}_{2}} ) .$$

In the lth stage while l>2, the resulting two-tier structured array, composed of the first (l−1) kernels may be considered as the inner kernel. With the inner kernel being configured, a sparse i-tier kernel may be configured to satisfy the following conditions MS21 and MS22.

In some cases, the condition MS21 may limit the 3 dB main lobe beamwidth of \tilde{ƒ}ₗ=ƒ₁(α₁,α₂)ƒ₂(α₁,α₂) . . . ƒₗ(α₁,α₂) within a respective value in each corresponding dimension (e.g., regarding two-dimension scenario, the condition MS21 may limit the 3 dB main lobe beamwidth of \tilde{ƒ}ₗ=ƒ₁(α₁,α₂)ƒ₂(α₁,α₂) . . . ƒₗ(α₁,α₂) within the first value

$$\frac{1}{{P}_{1} … {P}_{l}}$$

in the first dimension α₁ and within the second value

$$\frac{1}{{Q}_{1} … {Q}_{l}}$$

in the second dimension α₂).

In some cases, the condition MS22 may limit \tilde{ƒ}ₗ to be under the first threshold.

For the sequential procedure, the l-tier structured array A=Aₗ⊗ . . . A₂⊗A₁ may satisfy the condition (C1) with the threshold

$${Δ}_{1} = \frac{1}{{P}_{1} … {P}_{l}}$$

and the threshold

$${Δ}_{2} = \frac{1}{{Q}_{1} … {Q}_{l}}$$

and the condition (C2). Accordingly, when enhanced resolution is desired in both dimensions, a multi-tier structured array previously configured for a sensing task having lower resolution requirements may be reused. In such cases, the existing multi-tier structured array may be configured as an inner kernel, and one or more additional tiers may be constructed in a subsequent stage to further narrow a main lobe. In some implementations, this approach may eliminate a need to recalculate all kernels for a new sensing task.

In some embodiments, the TX/RX may determine a plurality of kernels of an array associated with a resource allocation. The plurality of kernels may include a first kernel and a second kernel. The array may be configured such that (i.e., may be determined to satisfy the following conditions): (1) a half power beamwidth (i.e., half power mainlobe beamwidth) of PSF associated with the array is within a respective threshold in each corresponding dimension (e.g., in two-dimension scenario, the half power beamwidth of PSF associated with the array is within a threshold Δ1 in a first dimension and within a threshold Δ2 in a second dimension); and (2) a number of non-zero elements of the first kernel is associated with a first value and a number of non-zero elements of the second kernel is associated with a second value. In some cases, the determination of the plurality of kernels of the array may reduce a PSL of PSF associated with the array.

In some implementations, an objective may be to construct a sparse array (i.e., matrix) A that satisfies the following conditions: (C1) the half power mainlobe beamwidth of PSF ƒ(α₁,α₂) is within a respective threshold along each corresponding dimension (e.g., in two-dimensional scenario, the half power mainlobe beamwidth of PSF is within the threshold Δ1 along the first dimension α₁ and within the threshold Δ2 along the second dimension α₂; and (C2′) the number of non-zero elements of the first kernel is associated with the first value and the number of non-zero elements of the second kernel is associated with the second value.

Accordingly, a 2-tier structured sparse array (i.e., the sparse array including a sparse inner kernel and a sparse outer kernel) that satisfies conditions associated with the half power main lobe beamwidth and the numbers of non-zero elements in the kernels may be constructed in a sequential procedure, as described below.

In the first stage, the sparse inner kernel (i.e., the first kernel A₁) may be configured to reduce a magnitude of an inner PSF factor (i.e., ƒ₁(α₁,α₂)) within grating lobe regions of an outer PSF factor (i.e., ƒ₂(α₁,α₂)), over the area of interest T, under the following conditions S11′-inner, S12′-inner and S13′-inner.

In some cases, the condition S11′-inner may limit the number of non-zero elements in the sparse inner kernel (i.e., the first kernel A₁) to be less than the first value N₁. The sparse inner kernel may be configured to reduce a magnitude of PSF associated with the first kernel within a grating lobe region associated with the second kernel, over an area of interest.

In some cases, the condition S12′-inner may limit the half power main lobe beamwidth of the inner PSF factor (i.e., ƒ₁(α₁,α₂)) associated with the sparse inner kernel (i.e., the first kernel A₁) within a respective value in each corresponding dimension (e.g., in two-dimension scenario, the condition S1-inner may limit the half power main lobe beamwidth of the inner PSF factor associated with the sparse inner kernel within

$$\frac{1}{{P}_{1}}$$

in the first dimension α₁ and within

$$\frac{1}{{Q}_{1}}$$

in the second dimension α₂).

In some cases, the condition S3-inner may limit the inner PSF factor (i.e., ƒ₁(α₁,α₂)) associated with the sparse inner kernel (i.e., the first kernel A₁) to be less than a predefined value (e.g., a value around −3 dB) within the sidelobe region Ω_{i,s} associated with the sparse inner kernel (i.e., the first kernel A₁).

In second stage, after the sparse inner kernel (i.e., the first kernel A₁) is configured, the sparse outer kernel (i.e., the second kernel A₂) may be configured to reduce resulting PSF ƒ(α₁, α₂) within the sidelobe region

$${Ω}_{o , s}^{0 , 0}$$

associated with the sparse outer kernel (i.e., the second kernel A₂) under the following conditions S21′-outer and S22′-outer.

In some cases, the condition S21′-outer may limit the half power main lobe beamwidth of resulting PSF ƒ(α₁, α₂) associated with the sparse array (i.e., the array A) within the respective threshold within each corresponding dimension (e.g., in two-dimensional scenario, the condition S21′-outer may limit the half power main lobe beamwidth of resulting PSF associated with the sparse array within the threshold Δ₁ in the first dimension α₁ and within the threshold Δ₂ in the second dimension α₂).

In some cases, the conditions S22′-outer may limit the number of non-zero elements in the sparse outer kernel (i.e., the second kernel A₂) to be less than the second value N₂. The sparse outer kernel may be configured to reduce a magnitude of PSF associated with the array within a sidelobe region of the outer kernel, and the sidelobe region of the outer kernel may be in the sidelobe area within the two-dimensional (0,0)^{th} period.

It should be noted that this array configuration method associated with the non-zero elements condition may also be applied to the multi-dimensional array or the one-dimensional array.

In some implementations, an operation may be provided for determining activated elements (i.e., elements with value 1) in the kernel in each stage of the mentioned multi-kernel array determination procedure. In particular, to establish the two kernels in a configurable manner, a sequential selection method may be employed to determine array element positions. For each kernel, a sequential selection algorithm may be initiated with a set of M elements allocated for pilot transmission. In some cases, in order to satisfy a resolution requirement, each kernel may be initialized by selecting four elements located at four corner positions of an available two-dimensional time-frequency array, which serve as an initial inner kernel or outer kernel.

Thereafter, an mth element of a kernel may be selected for m>M. Assuming that a first m−1 elements allocated for sensing are fixed, a plurality of remaining elements within the kernel that are not utilized by a sensing signal, totaling P₁Q₁−m+1 elements (for the kernel as the inner kernel) or P₂Q₂−m+1 elements (for the kernel as the outer kernel), may be identified as candidate sensing RE positions. A PSL associated with the inner kernel or the outer kernel may be evaluated for each candidate position by temporarily adding a corresponding candidate element. The candidate element that yields a minimum PSL may then be selected as the mth element of the kernel.

The foregoing selection process may be iteratively repeated for m=M+1, M+2, . . . , until one or more termination conditions are satisfied, including: (i) a resulting PSL is lower than a prescribed threshold; (ii) further activation of additional elements no longer results in a reduction of the PSL; or (iii) a number of nonzero elements reaches a predetermined maximum value.

Given a set of parameters {Δ₁, Δ₂,γ,γ₁}associated with a sensing task and a set of kernel dimensions {P₁,P₂,Q₁,Q₂}, a sparse array satisfying conditions (C1) and (C2) (or (C2′) may be independently configured at the UE and at the network node by applying the sequential selection algorithm in conjunction with a parallel construction method.

In some implementations, a delay-Doppler response (i.e., PSF) in a Cyclic-Prefix (CP)-OFDM system may be mathematically equivalent to a two-dimension spectrum of a signal pattern in the frequency-time domain. Accordingly, a design of low-overhead sensing resource pattern may be formulated as a sparse array design problem.

For example, OFDM signals including a plurality of Resource Blocks (RBs) arranged in a 55×10 configuration are considered, wherein each RB includes 14 symbols and 12 subcarriers (i.e., 12×14 REs per RB). Accordingly, a total number of available REs is 660×140. For a subcarrier spacing of 30 kHz, a resulting transmission bandwidth is approximately 20 MHz, and a transmission duration corresponds to 10 slots.

The previously mentioned two-tier structured array is employed, in which one RB serves as an inner kernel having dimensions P₁=12 and Q₁=14, and an outer kernel has dimensions P₂×Q₂=50×10. A maximum unambiguous region in delay and Doppler is configured as α₁∈[0,1) and α₂∈[−0.5,0.5), respectively. The first threshold γ and the second threshold γ₁ are set as γ=γ₁=−13 dB.

In this example, the inner kernel includes 37 non-zero elements and the outer kernel includes 44 non-zero elements, thereby reducing sensing overhead to approximately 1.8% of the available REs. The results indicate that the mentioned sequential procedure achieves a PSL and a 3 dB mainlobe width that are comparable to those obtained using a parallel construction method and a full-RE allocation approach.

For another example, in order to enhance sensing resolution in both delay and Doppler domains, a wide bandwidth and a longer coherent processing interval (CPI) are available for the ISAC system. A three-tier structured array is employed, with parameters configured as P₁=12, P₂=55, P₃=25, Q₁=14, Q₂=10, and Q₃=5. A total number of available REs is 16500×700.

For a subcarrier spacing of 30 kHz, a resulting transmission bandwidth may be approximately 500 MHz, and a transmission duration may correspond to 50 slots. A maximum unambiguous region in delay and Doppler is configured as α₁∈[0,1) and α₂∈[−0.5,0.5), respectively. In this example, a first-tier kernel and a second-tier kernel obtained through the sequential procedure are identical to the inner kernel and the outer kernel, respectively, of the preceding example.

With the first-tier and second-tier kernels configured, a third-tier kernel is configured in a subsequent stage to further narrow a main lobe of the resulting PSF while maintaining the maximum unambiguous region. In this manner, enhanced sensing resolution is achieved without recalculating the previously constructed kernels.

### Illustrative Implementations

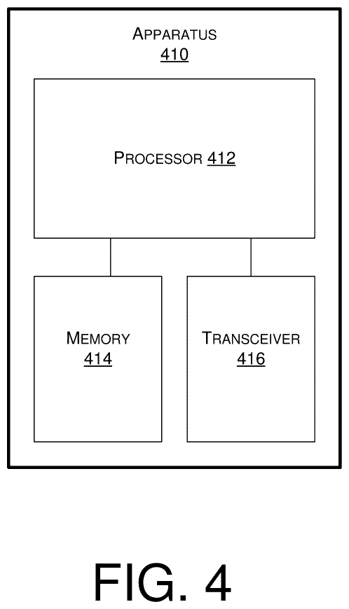

FIG. 4 illustrates an example apparatus 410 in accordance with an implementation of the present disclosure. Apparatus 410 may perform various functions to implement schemes, techniques, processes and methods described herein pertaining to determining an array associated with resource allocation with respect to TX and RX in an ISAC system, including scenarios/schemes described above as well as processes 500 and 600 described below.

Apparatus 410 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, apparatus 410 may be implemented in a smartphone, a smartwatch, a personal digital assistant, a digital camera, or a computing equipment such as a tablet computer, a laptop computer or a notebook computer. Apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, apparatus 410 may be implemented in a smart thermostat, a smart fridge, a smart door lock, a wireless speaker or a home control center. For instance, apparatus 410 may be implemented in an eNodeB in an LTE network, in a gNB in a 5G/NR, IoT, NB-IoT or IIoT network or in a satellite or base station in a 6G network. Alternatively, apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 410 may include at least some of those components shown in FIG. 4 such as a processor 412, for example. Apparatus 410 may further include one or more other components not pertinent to the proposed scheme of the present disclosure (e.g., internal power supply, display device and/or user interface device), and, thus, such component(s) of apparatus 410 are neither shown in FIG. 4 nor described below in the interest of simplicity and brevity.

In one aspect, processor 412 may be implemented in the form of one or more single-core processors, one or more multi-core processors, or one or more CISC processors. That is, even though a singular term “a processor” is used herein to refer to processor 412, processor 412 may include multiple processors in some implementations and a single processor in other implementations in accordance with the present disclosure. In another aspect, processor 412 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 412 is a special-purpose machine specifically designed, arranged and configured to perform specific tasks including determining an array associated with resource allocation in a device (e.g., as represented by apparatus 410) in accordance with various implementations of the present disclosure.

In some implementations, apparatus 410 may also include a transceiver 416 coupled to processor 412 and capable of wirelessly transmitting and receiving data. Transceiver 416 may comprise a transmitter and/or a receiver. In other words, processor 412 may transmit and/or receive the data such as configuration, message, signal, information, indicator, etc. via transceiver 416. In some implementations, apparatus 410 may further include a memory 414 coupled to processor 412 and capable of being accessed by processor 412 and storing data therein. Accordingly, apparatus 410 may wirelessly communicate with other network node via transceiver 416.

In some implementations, memory 414 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 414 may include a type of read-only memory (ROM) such as mask ROM, programmable ROM (PROM), erasable programmable ROM (EPROM) and/or electrically erasable programmable ROM (EEPROM). Alternatively, or additionally, memory 414 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

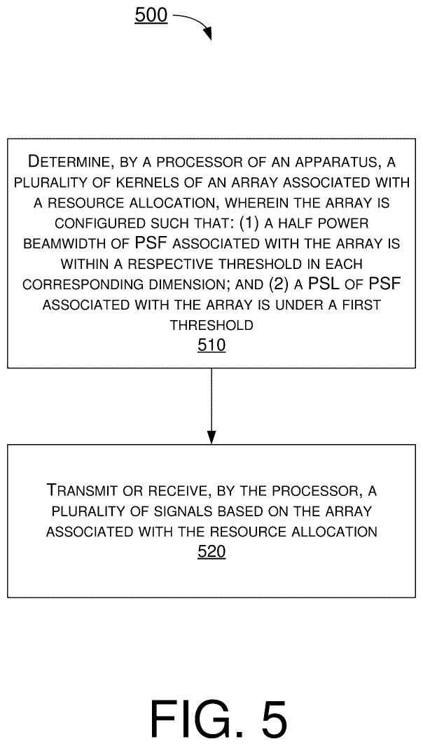

FIG. 5 illustrates an example process 500 in accordance with an implementation of the present disclosure. Process 500 may be an example implementation of above scenarios/schemes, whether partially or completely, with respect to determining an array associated with resource allocation of the present disclosure. Process 500 may represent an aspect of implementation of features of apparatus 410 as a TX/RX. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by TX/RX such as apparatus 410 or machine type devices. Solely for illustrative purposes and without limitation, process 500 is described below in the context of apparatus 410. Process 500 may begin at block 510.

At block 510, process 500 may involve processor 412 of apparatus 410 determining a plurality of kernels of an array associated with a resource allocation. The array may be configured such that: (1) a half power beamwidth of PSF associated with the array is within a respective threshold in each corresponding dimension; and (2) a PSL of PSF associated with the array is under a first threshold. Process 500 may proceed from block 510 to block 520.

At block 520, process 500 may involve processor 412 of apparatus 410 transmitting or receiving a plurality of signals based on the array associated with the resource allocation.

In some implementations, the plurality of kernels may include a first kernel and a second kernel, and the array may be a Kronecker product of the first kernel and the second kernel according to the following formula:

$$A = {A}_{2} ⊗ {A}_{1}$$

where A may be the array, A₁ may be the first kernel, and A₂ may be the second kernel. A size of the array may be P×Q, a size of A₁ may be P₁×Q₁, a size of A₂ may be P₂×Q₂, P may be equal to P₁×P₂, and Q may be equal to Q₁×Q₂. P, Q, P₁, Q₁, P₂, Q₂ are positive integers.

In some implementations, the first kernel may be configured such that a half power beamwidth of PSF associated with the first kernel is within a respective value in each corresponding dimension.

In some implementations, the first kernel may be configured such that a magnitude of PSF associated with the first kernel within a grating lobe region associated with the second kernel, over an area of interest, is less than a second threshold.

In some implementations, the first kernel may be configured such that, within a sidelobe region associated with the first kernel, the magnitude of PSF associated with the first kernel is less than a predefined value.

In some implementations, the second threshold may be equal to or less than the first threshold.

In some implementations, the second kernel may be configured such that the half power beamwidth of PSF associated with the array is within the respective threshold in each corresponding dimension after the first kernel is configured.

In some implementations, the second kernel may be configured such that, within a sidelobe region associated with the second kernel, an absolute value of PSF associated with the array is less than the first threshold. The sidelobe region associated with the second kernel may be within a multi-dimensional period.

In some implementations, the plurality of kernels may include kernels A₁ to A_{L}, and the array may be a Kronecker product of the plurality of kernels according to the following formula:

$$A = {A}_{L} ⊗ {A}_{L - 1} ⊗ {A}_{L - 2} ⊗ … ⊗ {A}_{2} ⊗ {A}_{1}$$

where a size of the array may be P×Q, a size of Aₗ may be Pₗ×Qₗ, P may be equal to P₁×P₂× . . . ×P_{L-1}×P_{L}, and Q may be equal to Q₁×Q₂× . . . ×Q_{L-1}×Q_{L}. P, Q, L, P₁ . . . P_{L}, Q₁ . . . Q_{L} are positive integers, and l is an positive integer no larger than L.

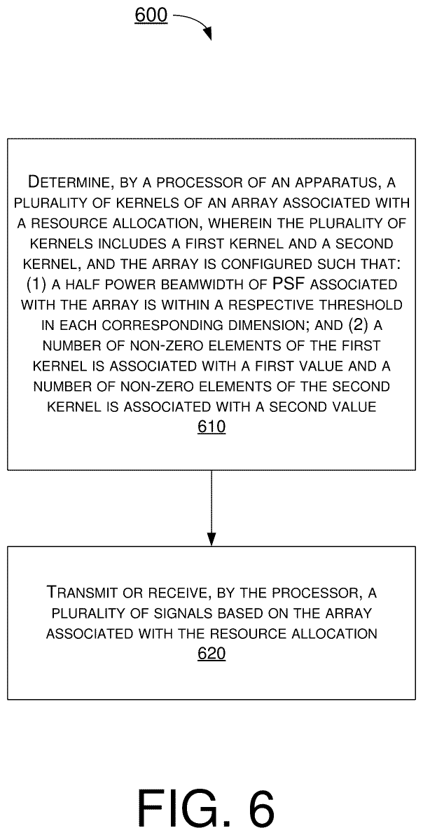

FIG. 6 illustrates an example process 600 in accordance with an implementation of the present disclosure. Process 600 may be an example implementation of above scenarios/schemes, whether partially or completely, with respect to determining an array associated with resource allocation of the present disclosure. Process 600 may represent an aspect of implementation of features of apparatus 410 as a TX/RX. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by TX/RX such as apparatus 410 or machine type devices. Solely for illustrative purposes and without limitation, process 600 is described below in the context of apparatus 410. Process 600 may begin at block 610.

At block 610, process 600 may involve processor 412 of apparatus 410 determining a plurality of kernels of an array associated with a resource allocation. The plurality of kernels may include a first kernel and a second kernel. The array may be configured such that: (1) a half power beamwidth of PSF associated with the array is within a respective threshold in each corresponding dimension; and (2) a number of non-zero elements of the first kernel is associated with a first value and a number of non-zero elements of the second kernel is associated with a second value. Process 600 may proceed from block 610 to block 620.

At block 620, process 600 may involve processor 412 of apparatus 410 transmitting or receiving a plurality of signals based on the array associated with the resource allocation.

In some implementations, the plurality of kernels may include a first kernel and a second kernel, and the array may be a Kronecker product of the first kernel and the second kernel according to the following formula:

$$A = {A}_{2} ⊗ {A}_{1}$$

where A may be the array, A₁ may be the first kernel, and A₂ may be the second kernel. A size of the array may be P×Q, a size of A₁ may be P₁×Q₁, a size of A₂ may be P₂×Q₂, P may be equal to P₁×P₂, and Q may be equal to Q₁×Q₂. P, Q, P₁, Q₁, P₂, Q₂ are positive integers.

In some implementations, the first kernel may be configured to reduce a magnitude of PSF associated with the first kernel within a grating lobe region associated with the second kernel, over an area of interest.

In some implementations, the first kernel may be configured such that a half power beamwidth of PSF associated with the first kernel is within a respective value in each corresponding dimension.

In some implementations, the first kernel may be configured such that, within a sidelobe region associated with the first kernel, the magnitude of PSF associated with the first kernel is less than a predefined value.

In some implementations, the second kernel may be configured such that the half power beamwidth of PSF associated with the array is within the respective threshold in each corresponding dimension after the first kernel is configured.

In some implementations, the second kernel may be configured to reduce a magnitude of PSF associated with the array within a sidelobe region of the second kernel, and the sidelobe region associated with the second kernel is within a multi-dimensional period.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a plurality of kernels of an array associated with a resource allocation, wherein the array is configured such that:
a half power beamwidth of Point Spread Function (PSF) associated with the array is within a respective threshold in each corresponding dimension; and
a Peak Sidelobe Level (PSL) of PSF associated with the array is under a first threshold; and
transmitting or receiving, by the processor, a plurality of signals based on the array associated with the resource allocation.

2. The method of claim 1, wherein the plurality of kernels includes a first kernel and a second kernel, and the array is a Kronecker product of the first kernel and the second kernel according to the following formula:
$$A = {A}_{2} ⊗ {A}_{1}$$
where A is the array, A₁ is the first kernel, A₂ is the second kernel,
wherein a size of the array is P×Q, a size of A₁ is P₁×Q₁, a size of A₂ is P₂×Q₂, P is equal to P₁×P₂, and Q is equal to Q₁×Q₂, wherein P, Q, P₁, Q₁, P₂, Q₂ are positive integers.

3. The method of claim 2, wherein the first kernel is configured such that:
a half power beamwidth of PSF associated with the first kernel is within a respective value in each corresponding dimension.

4. The method of claim 3, wherein the first kernel is configured such that:
a magnitude of PSF associated with the first kernel within a grating lobe region associated with the second kernel, over an area of interest, is less than a second threshold.

5. The method of claim 4, wherein the first kernel is configured such that:
within a sidelobe region associated with the first kernel, the magnitude of PSF associated with the first kernel is less than a predefined value.

6. The method of claim 4, wherein the second threshold is equal to or less than the first threshold.

7. The method of claim 2, wherein the second kernel is configured such that:
the half power beamwidth of PSF associated with the array is within the respective threshold in each corresponding dimension after the first kernel is configured.

8. The method of claim 7, wherein the second kernel is configured such that:
within a sidelobe region associated with the second kernel, an absolute value of PSF associated with the array is less than the first threshold,
wherein the sidelobe region associated with the second kernel is within a multi-dimensional period.

9. The method of claim 1, wherein the plurality of kernels includes kernels A₁ to A_{L}, and the array is a Kronecker product of the plurality of kernels according to the following formula:
$$A = {A}_{L} ⊗ {A}_{L - 1} ⊗ {A}_{L - 2} ⊗ … ⊗ {A}_{2} ⊗ {A}_{1}$$
wherein a size of the array is P×Q, a size of Aₗ is Pₗ×Qₗ, P is equal to P₁×P₂× . . . ×P_{L-1}×P_{L}, and Q is equal to Q₁×Q₂× . . . ×Q_{L-1}×Q_{L}, wherein P, Q, L, P₁ . . . P_{L}, Q₁ . . . Q_{L} are positive integers, and l is an positive integer no larger than L.

10. A method, comprising:
determining, by a processor of an apparatus, a plurality of kernels of an array associated with a resource allocation, wherein the plurality of kernels include a first kernel and a second kernel, and the array is configured such that:
a half power beamwidth of Point Spread Function (PSF) associated with the array is within a respective threshold in each corresponding dimension; and
a number of non-zero elements of the first kernel is associated with a first value and a number of non-zero elements of the second kernel is associated with a second value; and
transmitting or receiving, by the processor, a plurality of signals based on the array associated with the resource allocation.

11. The method of claim 10, wherein the array is a Kronecker product of the first kernel and the second kernel according to the following formula:
$$A = {A}_{2} ⊗ {A}_{1}$$
where A is the array, A₁ is the first kernel, A₂ is the second kernel,
wherein a size of the array is P×Q, a size of A₁ is P₁×Q₁, a size of A₂ is P₂×Q₂, P is equal to P₁×P₂, and Q is equal to Q₁×Q₂, wherein P, Q, P₁, Q₁, P₂, Q₂ are positive integers.

12. The method of claim 11, wherein the first kernel is configured to reduce a magnitude of PSF associated with the first kernel within a grating lobe region associated with the second kernel, over an area of interest.

13. The method of claim 11, wherein the first kernel is configured such that:
a half power beamwidth of PSF associated with the first kernel is within a respective value in each corresponding dimension.

14. The method of claim 13, wherein the first kernel is configured such that:
within a sidelobe region associated with the first kernel, a magnitude of PSF associated with the first kernel is less than a predefined value.

15. The method of claim 11, wherein the second kernel is configured such that:
the half power beamwidth of PSF associated with the array is within the respective threshold in each corresponding dimension after the first kernel is configured.

16. The method of claim 15, wherein the second kernel is configured to reduce a magnitude of PSF associated with the array within a sidelobe region of the second kernel, and the sidelobe region associated with the second kernel is within a multi-dimensional period.

17. An apparatus, comprising:
at least one of a transmitter and a receiver which, during operation, wirelessly communicates with a wireless network; and
a processor communicatively coupled to the at least one of the transmitter and the receiver, the processor being configured to perform operations comprising:
determining a plurality of kernels of an array associated with a resource allocation, wherein the array is configured such that:
a half power beamwidth of Point Spread Function (PSF) associated with the array is within a respective threshold in each corresponding dimension; and
a Peak Sidelobe Level (PSL) of PSF associated with the array is under a first threshold; and
transmitting, via the transmitter, or receiving, via the receiver, a plurality of signals based on the array associated with the resource allocation.

18. The apparatus of claim 17, wherein the plurality of kernels includes a first kernel and a second kernel, and the array is a Kronecker product of the first kernel and the second kernel according to the following formula:
$$A = {A}_{2} ⊗ {A}_{1}$$
where A is the array, A₁ is the first kernel, A₂ is the second kernel,
wherein a size of the array is P×Q, a size of A₁ is P₁×Q₁, a size of A₂ is P₂×Q₂, P is equal to P₁×P₂, and Q is equal to Q₁×Q₂, wherein P, Q, P₁, Q₁, P₂, Q₂ are positive integers, wherein the first kernel is configured such that:
a half power beamwidth of PSF associated with the first kernel is within a respective value in each corresponding dimension;
a magnitude of PSF associated with the first kernel within a grating lobe region associated with the second kernel, over an area of interest, is less than a second threshold; and
within a sidelobe region associated with the first kernel, the magnitude of PSF associated with the first kernel is less than a predefined value, and
wherein the second kernel is configured such that:
the half power beamwidth of PSF associated with the array is within the respective threshold within each corresponding dimension after the first kernel is configured; and
within a sidelobe region associated with the second kernel, an absolute value of PSF associated with the array is less than the first threshold, wherein the sidelobe region associated with the second kernel is within a multi-dimensional period.

19. An apparatus, comprising:
at least one of a transmitter and a receiver which, during operation, wirelessly communicates with a wireless network; and
a processor communicatively coupled to the at least one of the transmitter and the receiver, the processor being configured to perform operations comprising:
determining a plurality of kernels of an array associated with a resource allocation, wherein the plurality of kernels include a first kernel and a second kernel, and the array is configured such that:
a half power beamwidth of Point Spread Function (PSF) associated with the array is within a respective threshold in each corresponding dimension; and
a number of non-zero elements of the first kernel is associated with a first value and a number of non-zero elements of the second kernel is associated with a second value; and
transmitting, via the transmitter, or receiving, via the receiver, a plurality of signals based on the array associated with the resource allocation.

20. The apparatus of claim 19, wherein the array is a Kronecker product of the first kernel and the second kernel according to the following formula:
$$A = {A}_{2} ⊗ {A}_{1}$$
where A is the array, A₁ is the first kernel, A₂ is the second kernel,
wherein a size of the array is P×Q, a size of A₁ is P₁×Q₁, a size of A₂ is P₂×Q₂, P is equal to P₁×P₂, and Q is equal to Q₁×Q₂, wherein P, Q, P₁, Q₁, P₂, Q₂ are positive integers, wherein the first kernel is configured to reduce a magnitude of PSF associated with the first kernel within a grating lobe region associated with the second kernel, over an area of interest, and the first kernel is configured such that:
a half power beamwidth of PSF associated with the first kernel is within a respective value in each corresponding dimension; and
within a sidelobe region associated with the first kernel, the magnitude of PSF associated with the first kernel is less than a predefined value, and
wherein the second kernel is configured to reduce a magnitude of PSF associated with the array within a sidelobe region of the second kernel, the sidelobe region associated with the second kernel is within a multi-dimensional period, and the second kernel is configured such that:
the half power beamwidth of PSF associated with the array is within the first threshold in the first dimension and within the second threshold in the second dimension after the first kernel is configured.
